(19) United States
(12) Patent Application Publication
(10) Pub. No.: US 2023/0171374 A1
(43) Pub. Date: Jun. 1, 2023

(54) Screen control system

(71) Applicant: NOVATEK Microelectronics Corp., Hsin-Chu (TW)

(72) Inventors: Chun-Tang Yang, Hsinchu City (TW); Jin-Ho Lin, Hsinchu County (TW); Yung-Yang Huang, Hsinchu City (TW); Che-Chang Yang, Hsinchu City (TW)

(73) Assignee: NOVATEK Microelectronics Corp., Hsin-Chu (TW)

(21) Appl. No.: 17/850,982

(22) Filed: Jun. 27, 2022

Related U.S. Application Data
(60) Provisional application No. 63/283,975, filed on Nov. 29, 2021.

(51) Int. Cl. H04N 5/268; G06F 3/14

(52) U.S. Cl. CPC H04N 5/268; G06F 3/1446

(57) ABSTRACT

A screen control system includes a source controller, a plurality of serial units, a plurality of forward channels and a plurality of feedback channels. The plurality of serial units are coupled in series, coupled to the source controller, and configured to control a display screen. Each of the forward channels is coupled between two of the plurality of serial units or between one of the plurality of serial units and the source controller. The plurality of forward channels are configured to forward a video data and a command to the plurality of serial units from the source controller. Each of the feedback channels is coupled between two of the plurality of serial units or between one of the plurality of serial units and the source controller. The plurality of feedback channels are configured to forward a feedback data to the source controller from one of the plurality of serial units.

### CROSS REFERENCE TO RELATED APPLICATIONS

This application claims the benefit of U.S. Provisional Application No. 63/283,975, filed on Nov. 29, 2021. The content of the application is incorporated herein by reference.

### BACKGROUND OF THE INVENTION

### 1. Field of the Invention

The present invention relates to a screen control system, and more particularly, to a screen control system composed of a plurality of serial units.

### 2. Description of the Prior Art

Nowadays, a splicing screen is widely applied to realize a large-scale display screen. The splicing screen, which may be implemented with the liquid crystal display (LCD) or light-emitting diode (LED) display technology, is able to broadcast information to crowds of people simultaneously. For example, a digital signage may be realized by using an LED splicing screen set up in a crowded place, to show various information such as advertisements, movies or traffic information to people. The splicing screen is usually composed of a plurality of light boxes, each having a display panel, a data splitter, and/or one or more drivers and controllers. The driver(s) and controller(s) may be used to drive and control the display panel to show the desired image. The data splitter, which may be implemented in each light box or implemented in the video source delivering the video data, is configured to divide and allocate the video data to be shown in each fragment of the splicing screen.

In order to control the splicing screen, a source controller (such as a video source or a computer) is capable of transmitting a series of commands to set the controller in each of the light boxes. The light boxes are then able to receive video data after being set up. The command stream may be forwarded in various manners. For example, the command stream may be forwarded through a low-speed interface as compared to a high-speed interface used for the video data. These two interfaces are independent and have different transmission speeds. The low-speed command interface usually applies the half-duplex transmission scheme (where only one of read and write operations can be performed at a time), such that the command stream is forwarded slowly and requires a long delivery time, especially when the overall screen is large and composed of a great number of light boxes.

In another example, a bus connected between all the light boxes of the splicing screen may be applied to forward the command stream to the light boxes. Under a great number of light boxes of the large-scale splicing screen, the bus may be quite long physically, and thereby have large capacitive and resistive loads that limit the transmission speed of the command stream. Another delivery scheme is to use Ethernet to transmit the command stream and video data. However, due to the bandwidth limitation of the Ethernet, a great number of cables should be utilized to achieve enough transmission capability. The usage of numerous cable wires and corresponding I/O pins increases the overall system costs and reduces the operational speed of command transmission.

With the trends of high resolution and large scale of the LCD/LED screen, the number of light boxes may increase correspondingly. In such a situation, more time should be required to perform command transmission and parameter setting for the controllers in the light boxes. Therefore, how to improve the transmission speed of the command stream has become an important issue in this art.

### SUMMARY OF THE INVENTION

It is therefore an objective of the present invention to provide a screen control system, where the command stream and video data may be integrated in the same high-speed transmission interface to accelerate the command transmission and reduce the circuit costs by decreasing additional I/O pins.

An embodiment of the present invention discloses a screen control system, which comprises a source controller, a plurality of serial units, a plurality of forward channels and a plurality of feedback channels. The plurality of serial units are coupled in series, coupled to the source controller, and configured to control a display screen. Each of the plurality of forward channels is coupled between two of the plurality of serial units or between one of the plurality of serial units and the source controller. The plurality of forward channels are configured to forward a video data and a command to the plurality of serial units from the source controller. Each of the plurality of feedback channels is coupled between two of the plurality of serial units or between one of the plurality of serial units and the source controller. The plurality of feedback channels are configured to forward a feedback data to the source controller from one of the plurality of serial units.

Another embodiment of the present invention discloses a screen control system, which comprises a source controller, a plurality of serial units and a plurality of forward channels. The plurality of serial units are coupled in series, coupled to the source controller, and configured to control a display screen. Each of the plurality of forward channels is coupled between two of the plurality of serial units or between one of the plurality of serial units and the source controller. The plurality of forward channels are configured to forward a video data and a command to the plurality of serial units from the source controller. Wherein, the plurality of forward channels couple the source controller with the plurality of serial units to form a closed loop.

Another embodiment of the present invention discloses a screen control system, which comprises a source controller, a plurality of serial units and a plurality of forward channels. The plurality of serial units are coupled in series, coupled to the source controller, and configured to control a display screen. Each of the plurality of forward channels is coupled between two of the plurality of serial units or between one of the plurality of serial units and the source controller. The plurality of forward channels are configured to forward a video data and a command to the plurality of serial units from the source controller.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a screen control system according to an embodiment of the present invention.

FIG. 2 is a schematic diagram of a screen control system according to an embodiment of the present invention.

FIG. 3 is a schematic diagram of a feedforward circuit of a serial unit according to an embodiment of the present invention.

FIG. 4 is a schematic diagram of a feedback circuit of a serial unit according to an embodiment of the present invention.

FIG. 5 is an exemplary timing diagram of a display screen.

FIG. 6 illustrates that the command stream is transmitted in the blanking interval.

FIG. 7 illustrates several exemplary command formats applicable in the screen control system.

FIG. 8 illustrates that the command stream is transmitted in the blanking interval and also in the active interval.

FIG. 9 illustrates that a command stream is allocated to the empty time slots in the active interval and the invalid data bits in the blanking interval in an appropriate manner.

FIG. 10 illustrates an exemplary packet format used in the screen control system.

FIG. 11 illustrates another packet format used in the screen control system.

FIG. 12 is a schematic diagram of an arrangement of the command stream in the blanking interval according to an embodiment of the present invention.

FIG. 13 and FIG. 14 are schematic diagrams of arrangements of the command stream in multiple sub-channels of the blanking interval according to embodiments of the present invention.

FIG. 15 is a flowchart of a process according to an embodiment of the present invention.

FIG. 16 is a schematic diagram of an arrangement of the command stream in the active interval according to an embodiment of the present invention.

FIG. 17 is a schematic diagram of an arrangement of the command stream in multiple sub-channels according to an embodiment of the present invention.

FIG. 18 is a schematic diagram of another arrangement of the command stream according to an embodiment of the present invention.

FIG. 19 illustrates that an extended active interval contains all the sections of the command stream.

FIG. 20 illustrates that the sections of the command stream are allocated to different extended active intervals.

### DETAILED DESCRIPTION

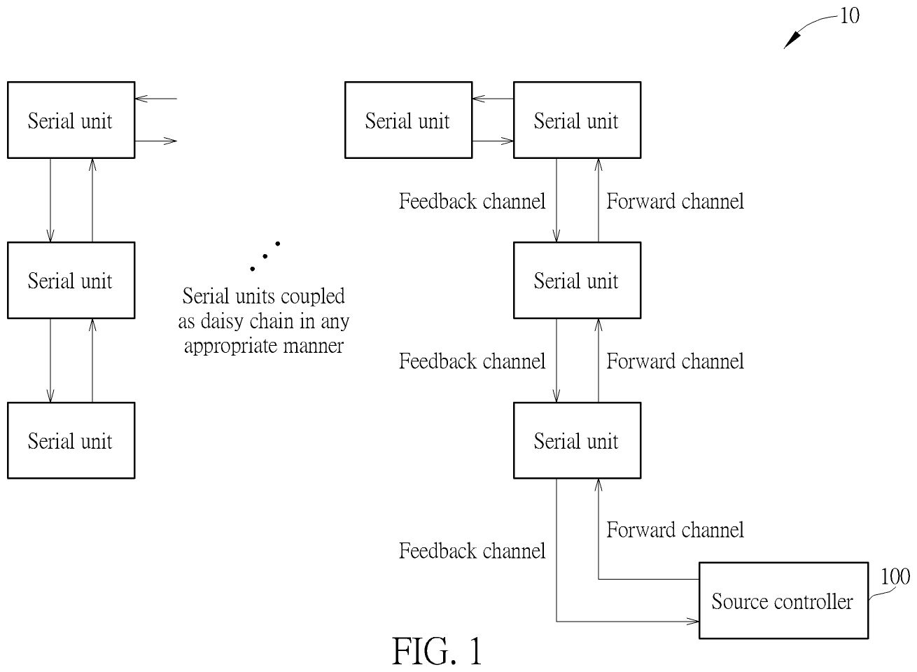

FIG. 1 is a schematic diagram of a screen control system 10 according to an embodiment of the present invention. As shown in FIG. 1, the screen control system 10 includes a plurality of serial units. Each of the serial units may be a light box having a display panel, a data splitter, and/or one or more drivers and controllers. The display panels of the serial units are used to construct a splicing screen. In other words, the splicing screen is composed of a plurality of display panels respectively included in a plurality of serial units. For example, if the splicing screen is a light-emitting diode (LED) splicing screen, the display panel of each serial unit may include an LED pixel array to serve as a fragment of the screen.

The screen control system 10 may further include a source controller 100. The source controller 100 may deliver a command stream for setting the serial units and also deliver video data to be displayed on the screen. The command stream may be used to set the controllers of the serial units, where the controllers may be a control circuit (e.g., integrated circuit (IC)) implemented in one or more chips. The controllers should be set up by receiving the commands, and may be able to operate normally and process the video data after being set up completely and successfully. The source controller 100 may be implemented with a video board, which may carry a main controller and/or may be connected to a computer. The video board may receive video content through a video interface such as the digital visual interface (DVI), high-definition multimedia interface (HDMI), video graphics array (VGA) or display port (DP), and convert the video content into video data receivable by the controllers of the serial units. Therefore, the video data may be transmitted to each serial unit through a high-speed transmission interface.

In this embodiment, the source controller 100 is coupled to the serial units in series through a plurality of forward channels and a plurality of feedback channels, where every two adjacent serial units are coupled to each other through a forward channel and a feedback channel, and the source controller 100 is coupled to the first serial unit (i.e., the serial unit in the first stage) through a forward channel and a feedback channel. The first serial unit is further coupled to the second serial unit (i.e., the serial unit in the second stage) through a forward channel and a feedback channel, the second serial unit is further coupled to the third serial unit (i.e., the serial unit in the third stage) through a forward channel and a feedback channel, and so on. Therefore, the serial units are cascaded as a daisy chain, and each serial unit is directly coupled between a previous serial unit and a next serial unit, except that the last serial unit (i.e., the serial unit in the last stage) is only coupled to a previous serial unit, and that the first serial unit is coupled between a next serial unit and the source controller 100. Under the connection scheme, the serial units may process the command and forward the command to the next stage, so that the number of serial units may be unlimitedly large with appropriate clock recovery and command processing. Therefore, the high-speed command and data transmissions in a large-scale high resolution splicing screen may be feasible.

As shown in FIG. 1, the serial units for constructing the splicing screen may be deployed as an array and coupled in any appropriate manner to form the daisy chain. For example, the serial units may be connected in an S-shaped manner, or connected in sequence from outside to inside. As long as all the serial units of the display screen are connected in series to form a daisy chain, the related implementation should belong to the scope of the present invention.

In the screen control system 10, both the video data and the command stream may be forwarded through the forward channels, and the feedback channels may be used to forward feedback data from any of the serial units to the source controller 100.

The forward channels may include any appropriate high-speed transmission interface such as the V-by-One interface, display port (DP) interface, high-definition multimedia interface (HDMI) and/or mobile industry processor interface (MIPI). The source controller 100 may send the video data and related commands through the high-speed transmission interface of the forward channels. More specifically, the source controller 100 may send the video data and commands to the serial unit in the first stage through the forward channel therebetween, and each serial unit (except for the last serial unit) may send the video data and commands to the next serial unit through the forward channel therebetween. In such a situation, both the video data transmission and command transmission are embedded in the same high-speed transmission interface, so that the command may be forwarded to each serial unit rapidly.

The commands are generally classified into two types: “write” and “read”. The “write” command may write the command data into one or several target serial units, to control the operations of the target serial unit(s). The “read” command allows the source controller 100 to read a specific status from one or several target serial units. For example, the source controller 100 may send a “read” command to a target serial unit, to instruct the target serial unit to return specific data, and such data may be, for example, the temperature, humidity and/or light emission status on the panel of the serial unit, but not limited thereto.

When receiving a command, a serial unit may determine whether this command is used for itself, and correspondingly receive and decode the command data to perform the corresponding operations (e.g., return the data in response to a “read” command or modify some setting(s) in response to a “write” command) or just forward this command to the next serial unit. In this embodiment, the feedback channel is applied to forward the feedback data from the serial units to the source controller; hence, the forward channels are dedicated to the command/data transmissions. More specifically, each serial unit may send the feedback data to its previous serial unit through the feedback channel therebetween, and the source controller 100 may receive the feedback data from the serial unit in the first stage through the feedback channel therebetween. The feedback channels may be realized by using any appropriate type of transmission interface, which may be the same as or different from the transmission interface used in the forward channels.

In this embodiment, the forward channels and the feedback channels are separate and unidirectional channels. Therefore, the commands and feedback data may be forwarded through different channels simultaneously, which improves the transmission speed of the commands, allowing the usage of more numbers of serial units in the large-scale splicing screen to be feasible.

Please note that FIG. 1 merely shows an exemplary embodiment of the connection manner applied to the screen control system. In another embodiment, in order to further reduce the circuit costs, the feedback channel may be omitted, and the feedback data may be forwarded through the forward channels.

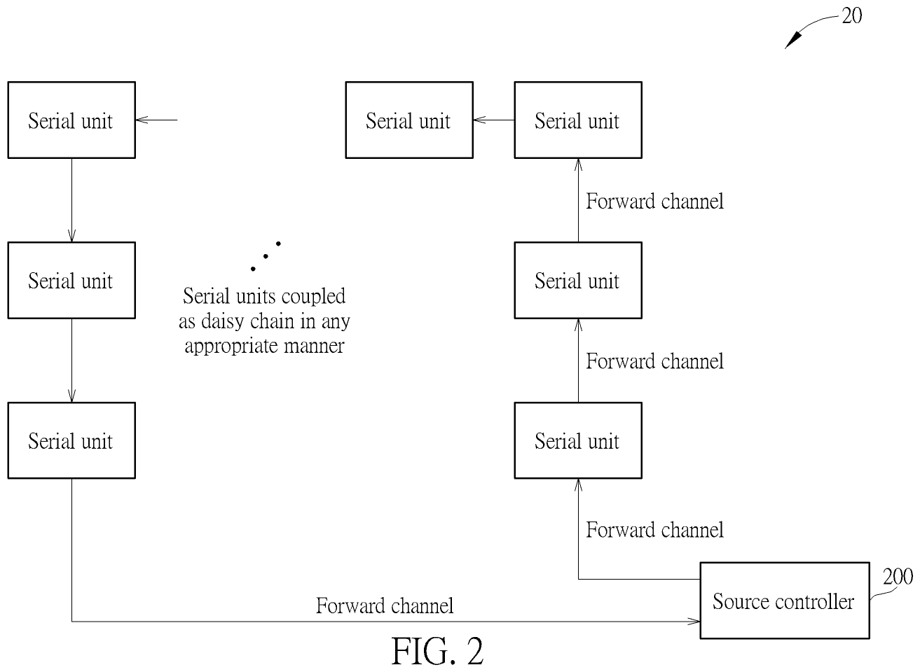

FIG. 2 is a schematic diagram of a screen control system 20 according to an embodiment of the present invention. As shown in FIG. 2, the screen control system 20 includes a source controller 200 and a plurality of serial units, which are coupled in series and coupled to the source controller 200. The operations of the serial units and the source controller 200 of the screen control system 20 are similar to those of the serial units and the source controller 100 of the screen control system 10, and will not be detailed herein. The difference between the screen control system 20 and the screen control system 10 is that, the screen control system 20 only includes the forward channels coupled between the serial units and the source controller 200 without any feedback channels.

In this embodiment, the serial units are also cascaded as a daisy chain, where every two adjacent serial units are coupled to each other through a forward channel, and the source controller 200 is coupled to the first serial unit (i.e., the serial unit in the first stage) through a forward channel. In addition, the source controller 200 is also coupled to the last serial unit (i.e., the serial unit in the last stage) through a forward channel. In such a situation, the forward channels couple the source controller 200 with the cascade serial units to form a closed loop.

In the connection scheme as shown in FIG. 2, the forward channels are unidirectional channels, and the feedback data may be forwarded and returned to the source controller 200 through the forward channel(s). More specifically, the source controller 200 may send the video data and related commands to the first serial unit, and each serial unit except for the last serial unit may send the video data and related commands to its next serial unit. When receiving a “read” command indicating that a feedback data is required, a serial unit may send the feedback data to its next serial unit, and so on. Finally, the last serial unit may return the feedback data to the source controller 200. The above data/command transmissions may be realized by using the forward channels only; hence, the feedback channel and related I/O pins may be removed, to further reduce the costs of redundant circuit wires and pins.

Similarly, in this connection scheme, the serial units may be deployed as an array and coupled in any appropriate manner. In an embodiment where the closed-loop connection is applied, the source controller 200 may deliver a command to check whether the connection path operates normally, to improve the stability of the screen control system 20. For example, if a command sent to the first serial unit is successfully and accurately received by the source controller 200 from the last serial unit, the source controller 200 may determine that the overall connection path can operate normally. In addition, the source controller 200 may also receive the video data from the last serial unit after the video data go through the entire loop; hence, the source controller 200 may check the accuracy of the video data (e.g., through a checking rule such as the cyclic redundancy check (CRC)), so as to determine whether the data transmission is performed normally.

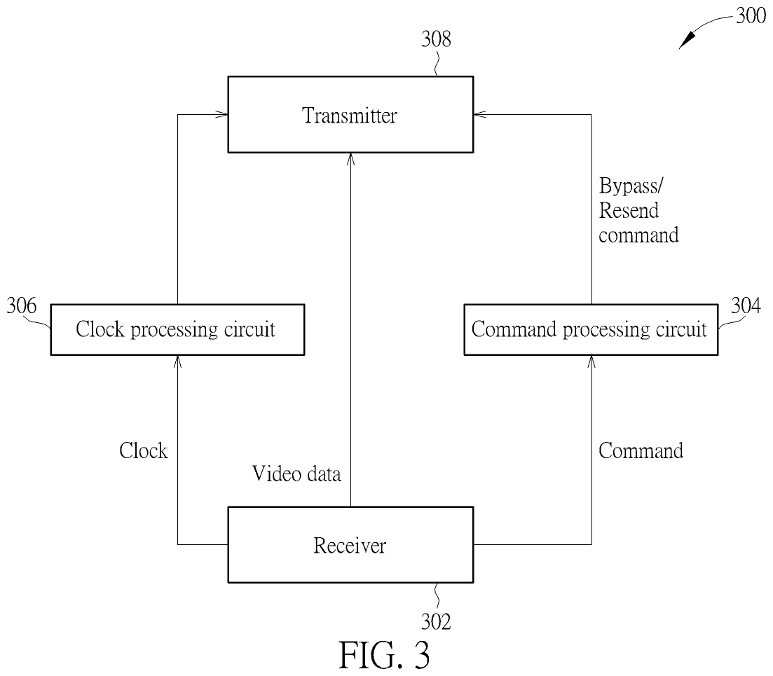

In order to realize the data/command transmissions, the serial units should be implemented with related control circuitry. FIG. 3 is a schematic diagram of a feedforward circuit 300 of a serial unit according to an embodiment of the present invention. The feedforward circuit 300 may be implemented in any serial unit of the screen control system 10 or 20. As shown in FIG. 3, the feedforward circuit 300 includes a receiver 302, a command processing circuit 304, a clock processing circuit 306 and a transmitter 308. The receiver 302 is configured to receive input signals from the serial unit in the previous stage (or from the source controller as for the first serial unit), and extract the command, video data and/or clock from the input signals. The command processing circuit 304 is configured to process the command or bypass the command. More specifically, the command processing circuit 304 may decode the command and determine whether to perform operations based on the command or just bypass the command, and resend the command to the next serial unit. In an embodiment, the command processing circuit 304 may modify the command to generate the modified command dedicated to the next serial unit. The clock processing circuit 306, which may include a phase-locked loop (PLL) or any other appropriate clock recovery circuit, may remove the clock jitter and/or recover the clock signal embedded in the input signal received by the serial unit. The transmitter 308 is configured to transmit the video data and the command to the serial unit in the next stage. More specifically, the transmitter 308 may combine the recovered clock signal with the command and/or the video data, and send them to the next serial unit.

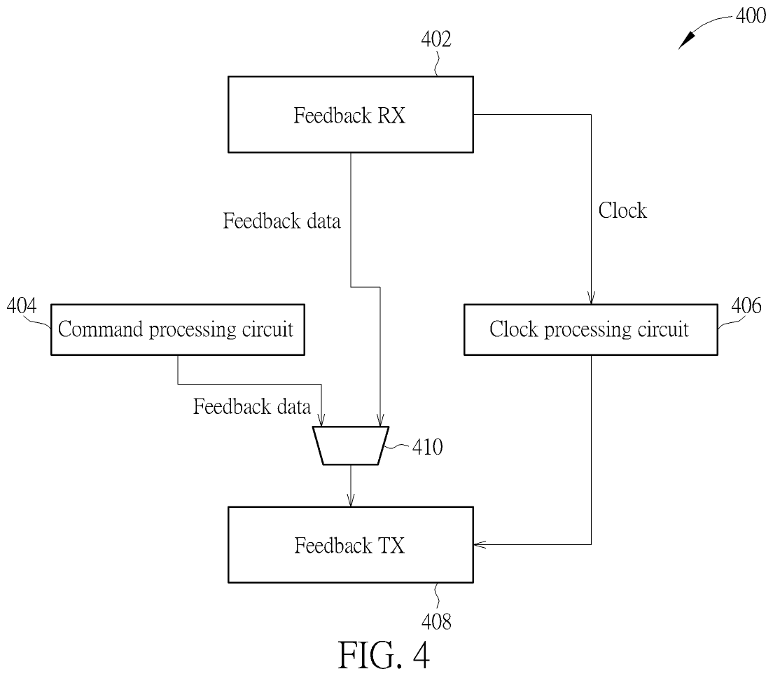

FIG. 4 is a schematic diagram of a feedback circuit 400 of a serial unit according to an embodiment of the present invention. The feedback circuit 400 may be implemented in any serial unit of the screen control system 10 where the feedback channels are deployed, to be used to transmit the feedback data. As shown in FIG. 4, the feedback circuit 400 includes a feedback receiver 402, a command processing circuit 404, a clock processing circuit 406, a feedback transmitter 408 and a multiplexer (MUX) 410. The feedback receiver 402 is configured to receive the feedback data from the serial unit in the next stage. The command processing circuit 404 is configured to generate a feedback data according to the received command. As mentioned above, the serial unit may generate the feedback data in response to the “read” command, and the command processing circuit 404 may serve this purpose. The command processing circuit 404 may be integrated with the command processing circuit 304 of the feedforward circuit 300, or may be implemented independently. The clock processing circuit 406 is similar to the clock processing circuit 306 of the feedforward circuit 300, to be used to process and recover the clock signal. The feedback transmitter 408 may transmit the feedback data to the serial unit in the previous stage, where the feedback data may include at least one of the feedback data generated by this serial unit and the feedback data received from the serial unit in the next stage. These feedback data may be integrated by using the MUX 410.

Please note that the screen control system 10 as shown in FIG. 1 includes the forward channels and the feedback channels, and thus the serial unit includes both the feedforward circuit 300 and the feedback circuit 400 to be used for the feedforward transmissions and the feedback transmissions, respectively. On the other hand, the screen control system 20 as shown in FIG. 2 only includes the forward channels, and thus only the feedforward circuit 300 is included in the serial unit. In this embodiment, the feedforward circuit 300 is used to transmit the feedback data in addition to the video data and command stream.

As mentioned above, the command stream and video data are embedded in a high-speed transmission interface to be transmitted through the same forward channels. The following embodiments describe how the command stream and the video data are integrated and embedded in the same high-speed transmission interface.

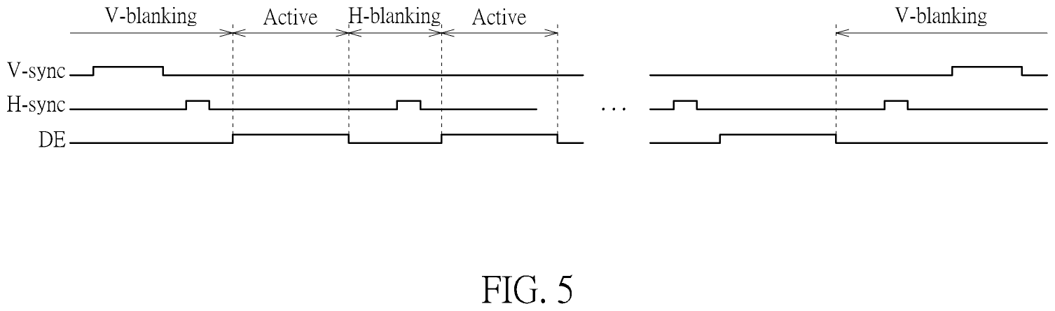

FIG. 5 is an exemplary timing diagram of a display screen, such as the splicing screen of a screen control system as described in this disclosure. In general, each display line period for displaying a line of video data may be divided into an active interval and a blanking interval. The video data are included in the active interval as indicated by the data enable signal DE. More specifically, the data enable signal DE in “High” level indicates the active intervals and in “Low” level indicates the horizontal blanking (H-blanking) or vertical blanking (V-blanking) intervals. The H-blanking interval is used to separate different line data, and the V-blanking interval is used to separate different frame data, as may be indicated by the horizontal synchronization signal H-sync and the vertical synchronization signal V-sync, respectively. Conventionally, no video data is transmitted in the H-blanking and V-blanking intervals, but these intervals still have transmission resources.

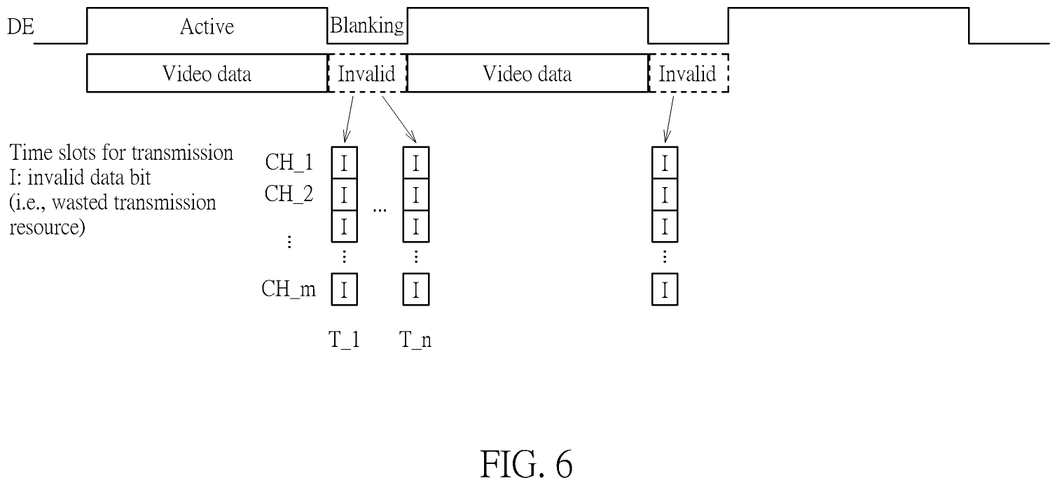

In order to efficiently utilize the transmission resources, in an embodiment, blanking intervals such as the H-blanking intervals and/or V-blanking intervals may be used to transmit the command stream. For example, in the screen control system, a forward channel coupled between two serial units may include m sub-channels CH_1-CH_m, as shown in FIG. 6. A blanking interval has n time slots T_1-T_n, where a symbol (e.g., I) indicates that one or more bits may be transmitted through each sub-channel CH_1-CH_m in each time slot T_1-T_n.

As shown in FIG. 6, the symbol “I”, representing the invalid data bit, denotes a time slot included in the blanking interval where no data bit is transmitted. Conventionally, the time slots in the blanking interval are wasted transmission resources in the video data format. In the present invention, these time slots in the blanking intervals may be used to transmit the command stream, while the active intervals may be used to transmit the video data, so that the command stream and the video data are embedded in the same high-speed transmission interface to be transmitted through the forward channels.

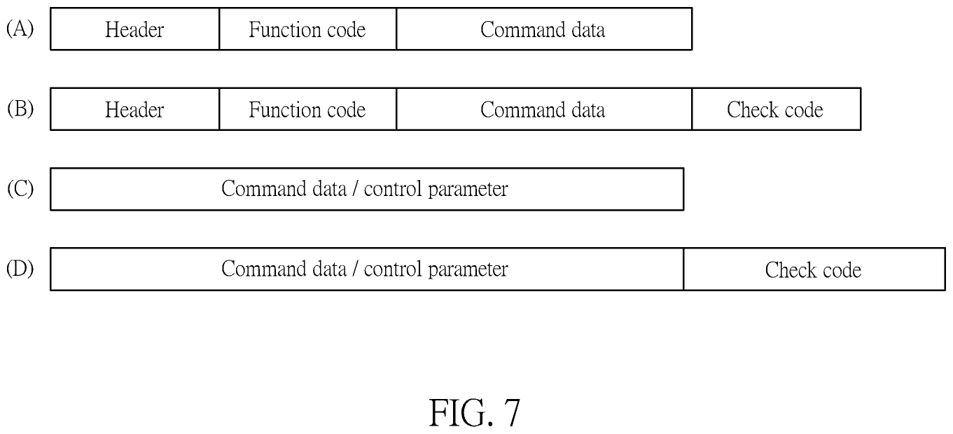

In an embodiment, the command may have a specific format recognizable by the serial units. FIG. 7 illustrates several exemplary command formats applicable in the screen control system. In detail, the command formats (A) and (B) include a header, a function code, and command data. The command format (B) further includes a command check code. The serial units may recognize the header to determine the start of a command stream. The function code may indicate the type of the command, which may be a “read” command, “write” command, or any other possible type. The command data refers to the content of the command. For example, the command data may include the values to be written into a specific register of the target serial unit(s) in a “write” command. The command check code is used to check whether this command is accurately received, to improve the robustness of the command transmission. Examples of the command check code may include the CRC, parity check and checksum, but not limited thereto.

In FIG. 7, the command formats (C) and (D) merely include the command data and/or control parameter, where no header and function code are included. The command format (D) further includes a command check code for checking the accuracy of the command. Since there is no header included in the command, the command stream may be synchronous to the horizontal synchronization signal H-sync, the vertical synchronization signal V-sync, or any other time point which is recognizable by the serial units. Therefore, the serial units may determine the start of the command stream according to the horizontal synchronization signal H-sync, the vertical synchronization signal V-sync, or other synchronized time point. Since there is no function code, the command data may include continuously transmitted display control parameters and/or address parameters, which may be received and processed by all of the serial units in the screen control system. Note that the command formats illustrated in FIG. 7 are merely several examples that may be applied in the screen control system, and should not be used to limit the scope of the present invention.

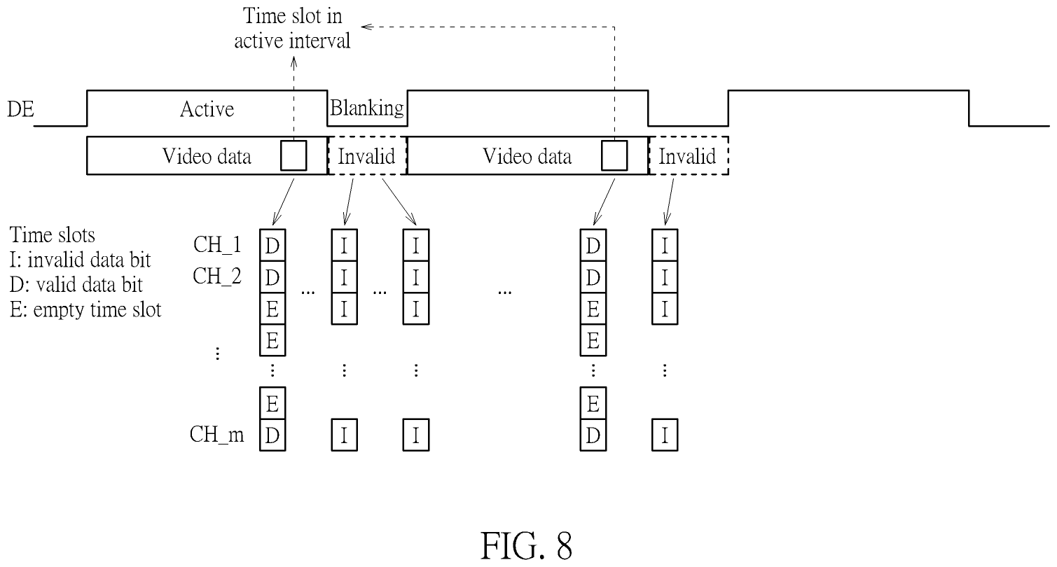

As described above, the command stream may be transmitted in the blanking interval of the display line period. In another embodiment, the command stream may also be transmitted in the active interval of the display line period, as shown in FIG. 8. FIG. 8 illustrates that the active interval includes several valid data bits (denoted by D) and several empty time slots (denoted by E). The valid data bits are those time slots used to transmit the video data. The empty time slots are additional time slots where no video data is transmitted in the active interval. In order to efficiently utilize the transmission resources, these empty time slots may be allocated to transmit the command stream.

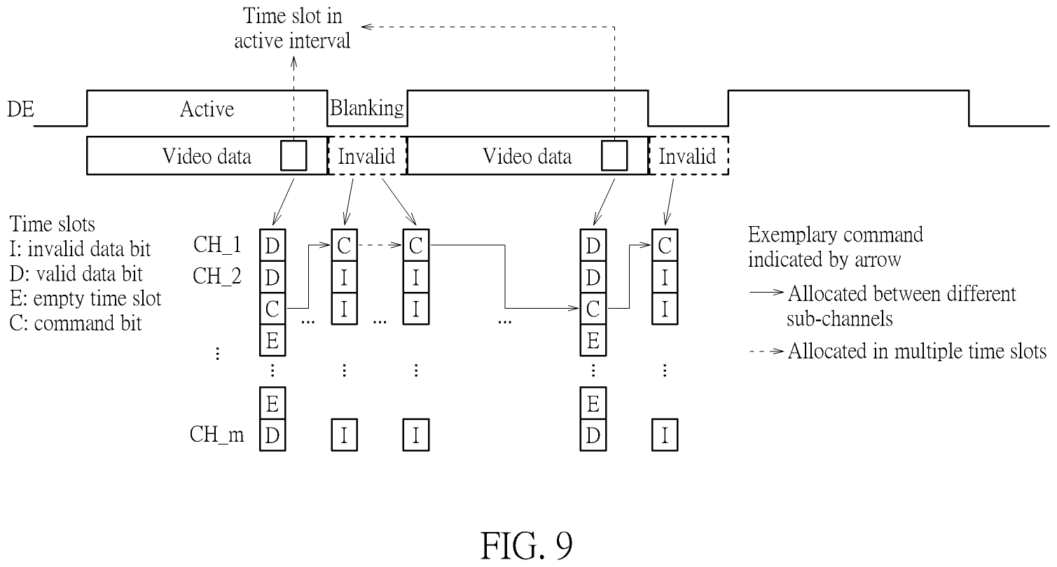

FIG. 9 illustrates that a command stream is allocated to the empty time slots in the active interval and the invalid data bits in the blanking interval in an appropriate manner. Among the sub-channels CH_0-CH_m, one or several empty time slots and one or several invalid data bits may be selected to transmit the command stream, where each selected time slot may be used to carry one or more bits. Each command bit (denoted by C) in the command stream may be sequentially transmitted in the selected time slots, as indicated by the arrow shown in FIG. 9. Note that the transmission scheme as shown in FIG. 9 is one of various implementations of the command bit allocation. In fact, the serial unit or the source controller may select any available transmission resources in the active interval and/or the blanking interval to perform the command transmission, where the selected time slots may be in the same sub-channel or different sub-channels. Correspondingly, the serial unit at the receiving side should be able to collect the command bits in the selected time slots to receive the command stream based on appropriate negotiation and/or specification in the screen control system.

In the above embodiments, the video data are transmitted with a dedicated data format defined based on the active intervals and the blanking intervals, where the command may be transmitted in appropriate time slots under the data format. In another embodiment, the video data is forwarded with packet transmission, where the video data are included in packets, and the serial unit may receive the video data by recognizing the packets, e.g., through the packet header. More specifically, the video data transmission does not follow the timing scheme specified by the vertical synchronization signal and the horizontal synchronization signal; instead, the video data are included in one or more packets transmitted at any appropriate time. In this manner, more video data may be transmitted during a unit of time.

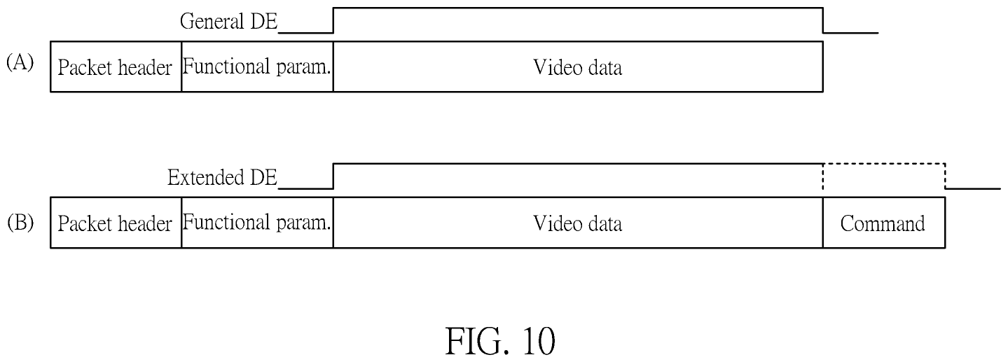

FIG. 10 illustrates an exemplary packet format used in the screen control system. The packet format (A) shows a general packet, which includes a packet header, a functional parameter, and a video data stream transmitted in sequence. The data enable signal DE (in “High” level) indicates the transmission time of video data. In an embodiment of the present invention, the packet length (i.e., the effective data enable period) may be extended, which generates an extended data enable period longer than the general data enable period in the packet format (A). As shown in the packet format (B) of FIG. 10, the data enable signal DE is extended, and the command stream is transmitted in the extended data enable period. More specifically, the command stream may be encoded as the format of the packet stream to be embedded in the extended data enable period, and thereby transmitted following the video data stream in the packet. When receiving the packet, the serial unit may perform decoding to separate the video data stream and the command stream, and thereby perform the corresponding operations indicated by the command.

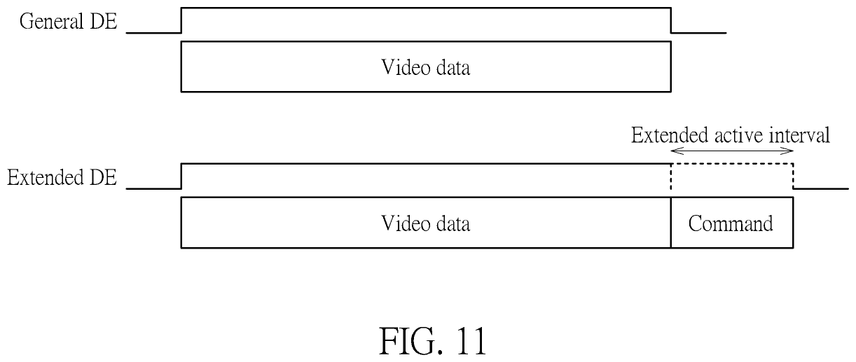

Please note that the method of extending the data enable signal DE may also be applicable to the timing scheme where the video data transmission is synchronous to the horizontal synchronization signal and the vertical synchronization signal. In such a situation, the extended data enable signal DE may be used to define an extended active interval, which occupies parts of the blanking interval, and the blanking interval length may be reduced. The command stream may be arranged as the format similar to the video data, to be transmitted in the extended active interval. The related implementation is shown in FIG. 11.

The difference between the embodiments of FIG. 11 and FIG. 10 is that the embodiment of FIG. 11 has no packet header and functional parameter. This is because this embodiment follows the timing scheme specified by the vertical synchronization signal and the horizontal synchronization signal (not illustrated), and the source controller and the serial units may perform video data transmission and reception based on the predetermined timing scheme. In the same manner, the source controller and the serial units may transmit and receive the command stream allocated after the video data based on the predetermined timing scheme and the same encoding manner.

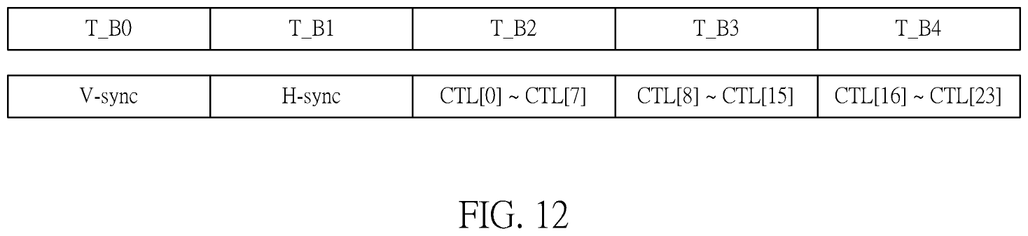

The abovementioned operations may be realized in several embodiments, where the V-by-One interface is applied as an example. In the first embodiment, the blanking interval may be used to transmit the command stream. In general, one blanking interval may include 5 time slots T_B0-T_B4, each of which is capable of carrying one byte of data (i.e., 8 data bits), as shown in FIG. 12.

In this embodiment, the time slots T_B0 and T_B1 are used to transmit the vertical synchronization signal V-sync and the horizontal synchronization signal H-sync, respectively. The time resources of the time slots T_B2-T_B4 are thereby available to transmit the command stream. More specifically, 24 command bits CTL[0]-CTL[23] may be transmitted in the time slots T_B2-T_B4 of this blanking interval.

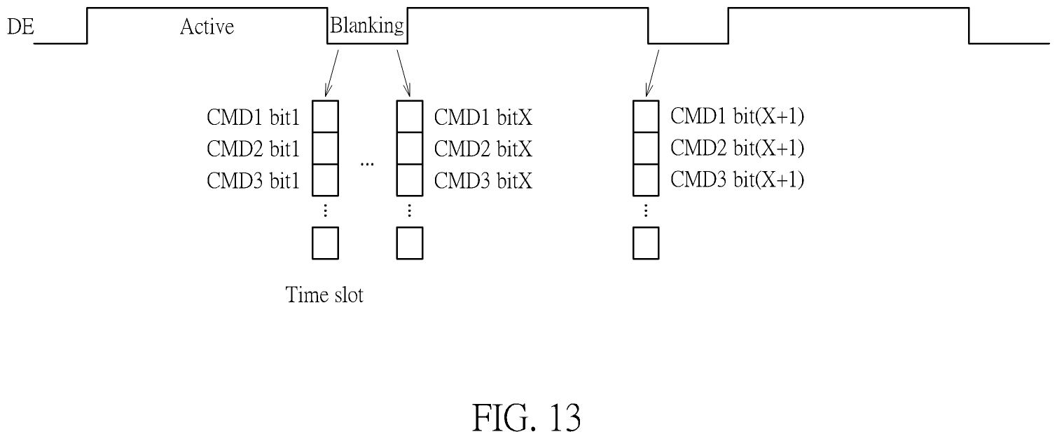

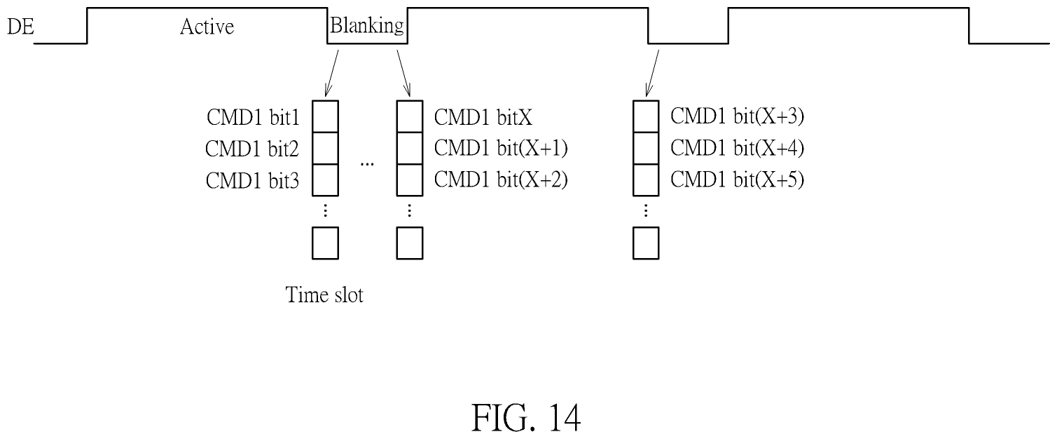

In several embodiments, there may be multiple time slots in different sub-channels included in the blanking interval; hence, the command stream may be arranged in serial and also in parallel to accelerate the speed of command transmission. FIGS. 13 and 14 are schematic diagrams of arrangements of the command stream in multiple sub-channels of the blanking interval according to embodiments of the present invention. As shown in FIG. 13, there are at least three command streams CMD1-CMD3 transmitted in the blanking intervals, where one command bit is transmitted in a time slot. In this embodiment, each of the command streams CMD1-CMD3 is transmitted through a respective sub-channel, where the command bits of the same command stream are transmitted in serial through the same sub-channel. In another embodiment as shown in FIG. 14, the command bits of the same command stream (e.g., CMD1) may be allocated to different sub-channels and thereby transmitted in parallel.

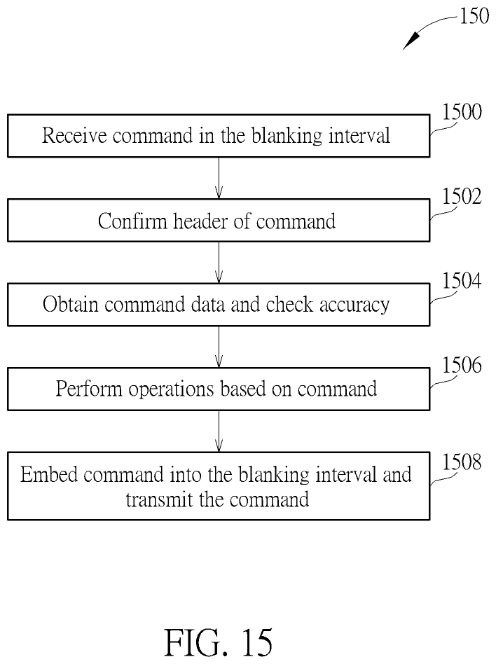

In this embodiment where the command stream is transmitted in the blanking interval, the serial unit may process the command stream by using a process 150, as shown in FIG. 15. The process 150 may be implemented in a feedforward circuit of a serial unit in a screen control system, such as the feedforward circuit 300 shown in FIG. 3. As shown in FIG. 15, the process 150 includes the following steps:

Step 1500: Receive command in the blanking interval.

Step 1502: Confirm header of command.

Step 1504: Obtain command data and check accuracy.

Step 1506: Perform operations based on command.

Step 1508: Embed command into the blanking interval and transmit the command.

According to the process 150, the serial unit may receive the command stream in the blanking interval through the receiver, and recognize and confirm the header to determine the start point of the command stream. The serial unit then obtains the command data in the command stream. After the entire command is obtained, the serial unit may check the accuracy of the command, e.g., through the command check code. If the command is determined to be accurate and the command indicates that it is used for the present serial unit, the serial unit may perform related operations (e.g., “read” or “write” operations as described above) based on the command. Subsequently, the transmitter of the serial unit may embed the command into the blanking interval and send the command to the next serial unit.

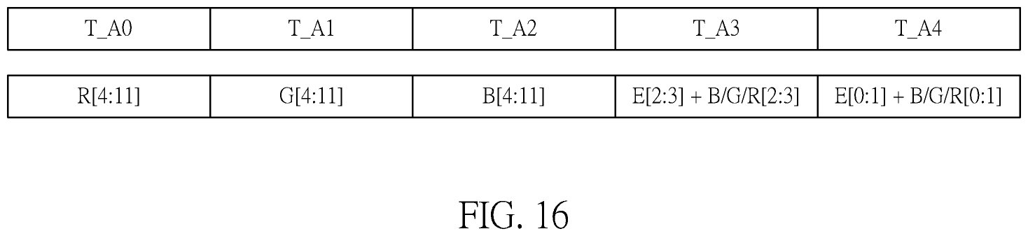

In the second embodiment, the empty transmission resources in the active interval may also be used to transmit the command stream. FIG. 16 is a schematic diagram of an arrangement of the command stream in the active interval according to an embodiment of the present invention. In this embodiment, the transmission timing of the V-by-One interface is taken as an example, where the video data of a pixel are allocated in 5 time slots T_A0-T_A4 to be transmitted. Each time slot is capable of carrying one byte of data; hence, the time slots T_A0-T_A4 totally have 40-bit transmission resources.

In detail, the pixel may include 3 subpixels and each subpixel may include 12 bits of data (e.g., R[0:11], G[0:11] or B[0:11]), which totally require 36-bit transmission resources, while the time slots T_A0-T_A4 include 40-bit transmission resources. In such a situation, 4 additional bits (which may be considered as the empty time slots as illustrated in FIG. 8 or 9) may be used to transmit the command, as denoted by E[2:3] in the time slot T_A3 and E[0:1] in the time slot T_A4. This implementation may be combined with any of the above embodiments as shown in FIG. 12 to FIG. 14, allowing the command stream to be transmitted in both the active interval and the blanking interval, so as to improve the transmission efficiency.

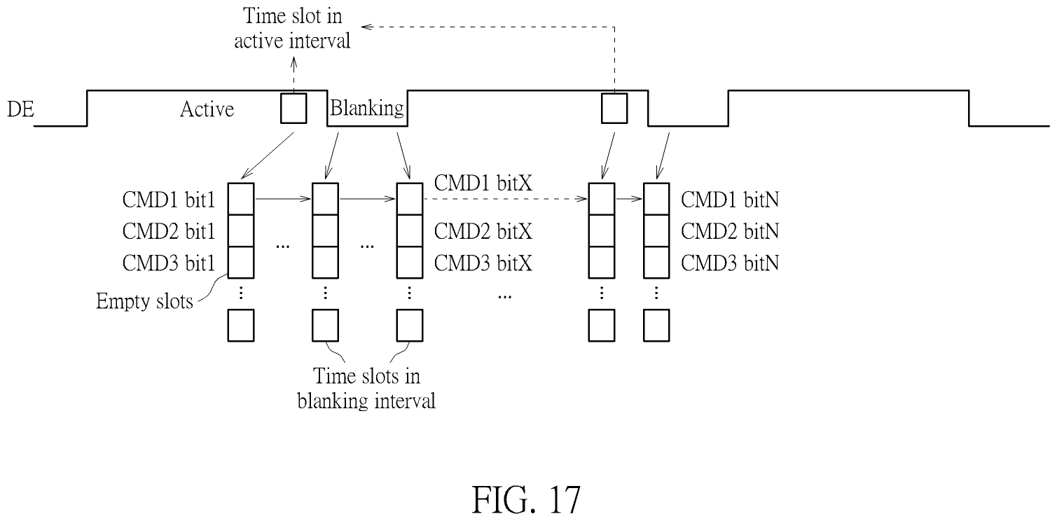

FIG. 17 is a schematic diagram of an arrangement of the command stream in multiple sub-channels according to an embodiment of the present invention, where the command bits are allocated in the time slots in both the active interval and the blanking interval. These time slots are available transmission resources for the command streams. As shown in FIG. 17, each of the command streams CMD1-CMD3 is transmitted through a respective sub-channel. A skilled person should know that the command streams may also be arranged by allocating the command bits of the same command stream to different sub-channels. Preferably, the screen control system should have a specified setting of command allocation, allowing the serial units to receive/transmit the command stream based on the specified allocation method.

In addition, the operations of the serial unit as illustrated in the process 150 may also be applicable to the embodiment where the empty time slots of the active interval are used to transmit the command stream. In such a situation, the serial unit may collect the bits of the command stream from the blanking interval and also from the empty time slots of the active interval. The transmitter of the serial unit may allocate the command bits in any available transmission resources in either or both of the active interval and the blanking interval.

In the third embodiment, the active interval defined by the data enable signal DE is extended, and the command stream is transmitted in the extended active interval (i.e., extended data enable period), as shown in FIG. 11.

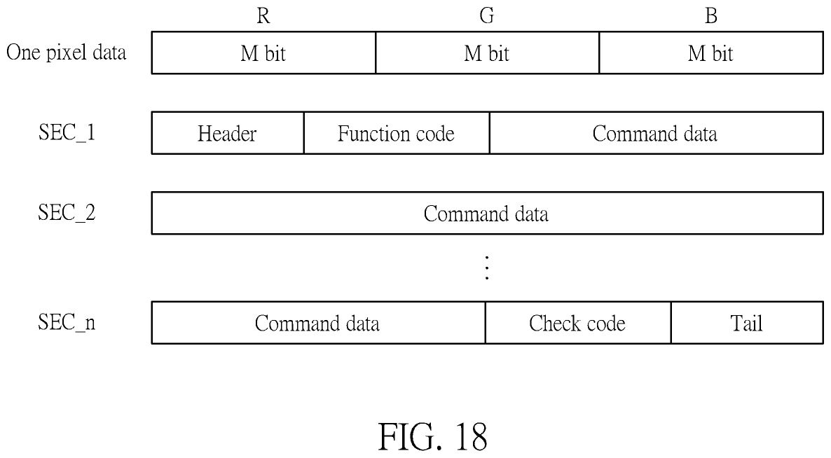

FIG. 18 is a schematic diagram of another arrangement of the command stream according to an embodiment of the present invention. As shown in FIG. 18, the pixel data format may have a unit of 3M bits for one pixel, where M bits are allocated to each subpixel (R, G or B). The command stream may be encoded with a unit of 3M bits to conform to the pixel data format, so that the command stream is able to be carried in the extended active interval following the video data. In this embodiment, the command stream, including a header, a function code, command data, a command check code and a tail, is allocated to have n sections SEC_1-SEC_n, and the length of each section equals 3M bits. Supposing that the size of the command stream is 60M bits in total, this command stream may be encoded to have 20 sections; that is, n is equal to 20.

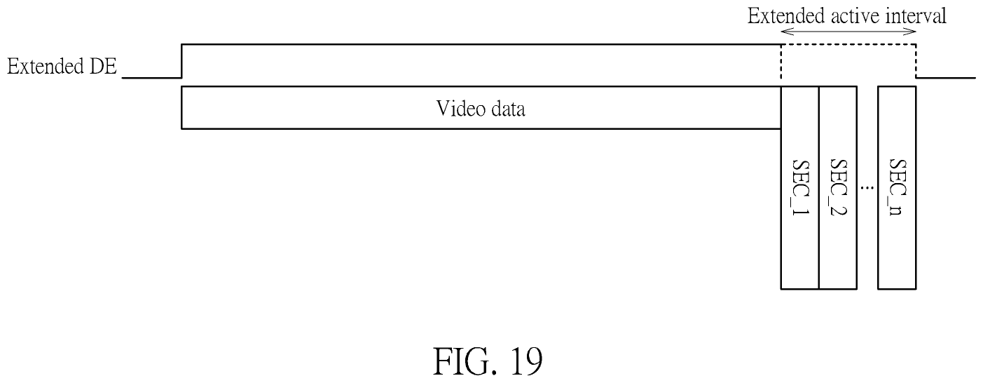

In an embodiment, the length of the extended active interval may be adjusted correspondingly, so as to contain the entire command stream. For example, as shown in FIG. 19, the extended active interval is long enough to contain the sections SEC_1-SEC_n of the command stream.

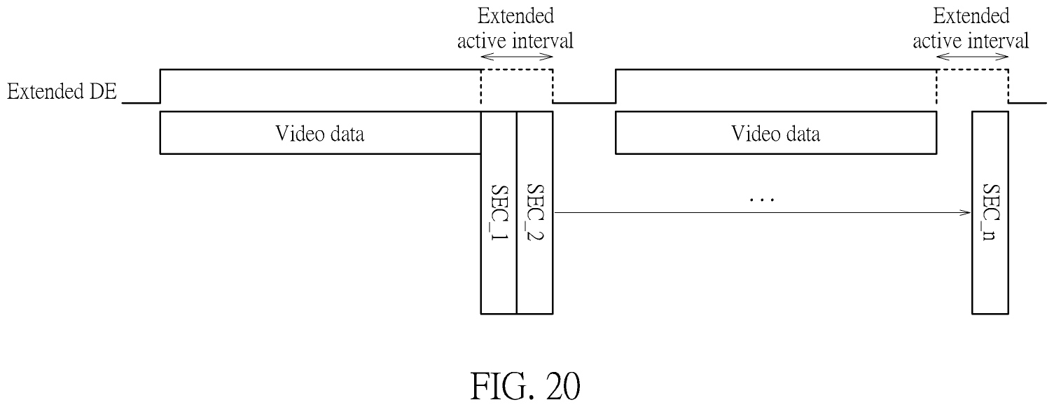

Note that the extended active interval occupies parts of the blanking interval, which has a limited length, causing that the maximum length of an extended active interval is limited. In another embodiment, if the length of the command stream exceeds the maximum possible length of the extended active interval, several sections of the command stream may be allocated to another extended active interval such as the extended active interval of the next display line period, as shown in FIG. 20.

In addition, the operations of the serial unit as illustrated in the process 150 may also be applicable to the embodiment where the command stream is transmitted in the extended active interval. In such a situation, the serial unit may receive the sections of the command stream in the extended active interval defined by the extended data enable signal DE. The serial unit may further encode the command into a format conforming to the pixel data format. Therefore, the transmitter of the serial unit may embed the command stream in the extended active interval to be transmitted.

To sum up, the present invention provides a screen control system where the video data and the command stream are transmitted through the same high-speed transmission interface, and a related method used for the serial unit(s) to realize the data/command transmissions. The screen control system may include a splicing screen composed of multiple serial units connected in series (i.e., cascade). A source controller may output a command stream to the serial unit in the first stage, and each serial unit forwards the command stream to the serial unit in the next stage.

In order to realize the integration of the command stream and video data in the high-speed transmission interface, in an embodiment, the command may be allocated to the blanking interval and/or the empty transmission resources in the active interval based on the timing scheme of video data transmission as defined by the horizontal synchronization and vertical synchronization signals. Alternatively, if the video data apply packet transmission, the packet length may be extended to contain the command stream. In an embodiment, between every two adjacent serial units, there are a forward channel for forwarding the video data and command to the serial units from the source controller and a feedback channel for forwarding the feedback data to the source controller from the serial units. In another embodiment, the source controller along with the serial units may be connected in series to form a closed loop, and the feedback data, video data and command may be transmitted through the forward channels to reach the source controller or any serial unit in the loop; hence, the feedback channel and related I/O pins may be omitted, so as to further reduce the circuit costs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A screen control system, comprising:
a source controller;
a plurality of serial units coupled in series, coupled to the source controller, and configured to control a display screen;
a plurality of forward channels, each coupled between two of the plurality of serial units or between one of the plurality of serial units and the source controller, configured to forward a video data and a command to the plurality of serial units from the source controller; and
a plurality of feedback channels, each coupled between two of the plurality of serial units or between one of the plurality of serial units and the source controller, configured to forward a feedback data to the source controller from one of the plurality of serial units.

2. The screen control system of claim 1, wherein the source controller is coupled to a first serial unit among the plurality of serial units, and configured to send the video data and the command to the first serial unit and receive the feedback data from the first serial unit.

3. The screen control system of claim 1, wherein a first serial unit among the plurality of serial units is configured to transmit the video data and the command to a second serial unit among the plurality of serial units through one of the plurality of forward channels, and the second serial unit is configured to transmit the feedback data to the first serial unit through one of the plurality of feedback channels.

4. The screen control system of claim 1, wherein the plurality of forward channels and the plurality of feedback channels are unidirectional channels.

5. The screen control system of claim 1, wherein at least one of the plurality of serial units comprises a feedforward circuit, which comprises:
a receiver, configured to receive the video data and the command from a previous serial unit among the plurality of serial units;
a command processing circuit, configured to process the command or bypass the command; and
a transmitter, configured to transmit the video data and the command to a next serial unit among the plurality of serial units.

6. The screen control system of claim 1, wherein at least one of the plurality of serial units comprises a feedback circuit, which comprises:
a feedback receiver, configured to receive a first feedback data from a next serial unit among the plurality of serial units;
a command processing circuit, configured to generate a second feedback data according to the command; and
a feedback transmitter, configured to transmit at least one of the first feedback data and the second feedback data to a previous serial unit among the plurality of serial units.

7. The screen control system of claim 1, wherein the command is transmitted in at least one of a blanking interval and an empty time slot of an active interval of a display line period.

8. The screen control system of claim 1, wherein the command comprises a header, allowing the plurality of serial units to determine a start of the command by recognizing the header.

9. The screen control system of claim 1, wherein the command is synchronous to a horizontal synchronization signal or a vertical synchronization signal for the display screen, allowing the plurality of serial units to determine a start of the command according to the horizontal synchronization signal or the vertical synchronization signal.

10. The screen control system of claim 1, wherein the command is contained in an extended data enable period indicated by a data enable signal, wherein the extended data enable period is longer than a general data enable period in which no command is contained.

11. The screen control system of claim 10, wherein the command is encoded to conform to a pixel data format of the screen control system, to be contained in the extended data enable period.

12. The screen control system of claim 1, wherein the plurality of forward channels comprise at least one of a V-by-One interface, a display port (DP) interface, a high-definition multimedia interface (HDMI) and a mobile industry processor interface (MIPI).

13. A screen control system, comprising:
a source controller;
a plurality of serial units coupled in series, coupled to the source controller, and configured to control a display screen; and
a plurality of forward channels, each coupled between two of the plurality of serial units or between one of the plurality of serial units and the source controller, configured to forward a video data and a command to the plurality of serial units from the source controller;
wherein the plurality of forward channels couple the source controller with the plurality of serial units to form a closed loop.

14. The screen control system of claim 13, wherein the source controller is coupled to a first serial unit among the plurality of serial units, and configured to send the video data and the command to the first serial unit.

15. The screen control system of claim 14, wherein the source controller is further coupled to a second serial unit among the plurality of serial units, and configured to receive a feedback data from the second serial unit through one of the plurality of forward channels.

16. The screen control system of claim 13, wherein the plurality of forward channels are unidirectional channels.

17. The screen control system of claim 13, wherein at least one of the plurality of serial units comprises a feedforward circuit, which comprises:
a receiver, configured to receive the video data and the command from a previous serial unit among the plurality of serial units;
a command processing circuit, configured to process the command or bypass the command; and
a transmitter, configured to transmit the video data and the command to a next serial unit among the plurality of serial units.

18. The screen control system of claim 13, wherein the command is transmitted in at least one of a blanking interval and an empty time slot of an active interval of a display line period.

19. The screen control system of claim 13, wherein the command comprises a header, allowing the plurality of serial units to determine a start of the command by recognizing the header.

20. The screen control system of claim 13, wherein the command is synchronous to a horizontal synchronization signal or a vertical synchronization signal for the display screen, allowing the plurality of serial units to determine a start of the command according to the horizontal synchronization signal or the vertical synchronization signal.

21. The screen control system of claim 13, wherein the command is contained in an extended data enable period indicated by a data enable signal, wherein the extended data enable period is longer than a general data enable period in which no command is contained.

22. The screen control system of claim 21, wherein the command is encoded to conform to a pixel data format of the screen control system, to be contained in the extended data enable period.

23. The screen control system of claim 13, wherein the plurality of forward channels comprise at least one of a V-by-One interface, a display port (DP) interface, a high-definition multimedia interface (HDMI) and a mobile industry processor interface (MIPI).

24. A screen control system, comprising:
a source controller;
a plurality of serial units coupled in series, coupled to the source controller, and configured to control a display screen; and
a plurality of forward channels, each coupled between two of the plurality of serial units or between one of the plurality of serial units and the source controller, configured to forward a video data and a command to the plurality of serial units from the source controller.

25. The screen control system of claim 24, further comprising:
a plurality of feedback channels, each coupled between two of the plurality of serial units or between one of the plurality of serial units and the source controller, configured to forward a feedback data to the source controller from one of the plurality of serial units.

26. The screen control system of claim 24, wherein the plurality of forward channels couple the source controller with the plurality of serial units to form a closed loop.
